(19) United States
(12) Patent Application Publication
(10) Pub. No.: US 2011/0006551 A1
(43) Pub. Date: Jan. 13, 2011

(54) LATCH ASSEMBLY AND DETENT LEVER THEREOF

(75) Inventors: Jeffrey L. Konchan, Romeo, MI (US); Scott E. Wilbanks, Novi, MI (US); Michael F. Erickson, Warren, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/499,166

(22) Filed: Jul. 8, 2009

(51) Int. Cl. E05C 3/16

(52) U.S. Cl. 292/216; 292/217

(57) ABSTRACT

A latch assembly includes a frame configured for attachment to a vehicle and having a base. The latch assembly also includes a fork bolt rotatably attached to the frame, and a detent lever rotatably attached to the frame. The detent lever includes a first arm and a second arm substantially perpendicular to the first arm. The first arm is configured for retaining the fork bolt in a latched position and has a tab. The first arm presents a first surface extending along a plane substantially parallel to the base. The tab presents a second surface spaced apart from and substantially parallel to the first surface that is configured for optimizing alignment between the fork bolt and the detent lever in the latched position.

### TECHNICAL FIELD

The present invention generally relates to fastening devices for vehicles, and more specifically, to a latch assembly and detent lever thereof.

### BACKGROUND OF THE INVENTION

Vehicle elements that are pivotably coupled to other elements, such as a vehicle hood and a vehicle body, may be secured via interaction between a latch assembly and a striker assembly. In particular, when the vehicle hood is in a latched position, a fork bolt of the latch assembly may be retained by a detent lever of the latch assembly and engage with a striker of the striker assembly to thereby latch the vehicle hood to the vehicle body. As such, advantages may be obtained by optimizing alignment of the detent lever and the fork bolt in the latched position.

### SUMMARY OF THE INVENTION

A latch assembly includes a frame configured for attachment to a vehicle and having a base. The latch assembly further includes a fork bolt rotatably attached to the frame, and a detent lever rotatably attached to the frame. The detent lever includes a first arm and a second arm substantially perpendicular to the first arm. The first arm presents a first surface extending along a plane substantially parallel to the base. The first arm is configured for retaining the fork bolt in a latched position and has a tab. The tab presents a second surface spaced apart from and substantially parallel to the first surface that is configured for optimizing alignment between the fork bolt and the detent lever in the latched position.

In one aspect, the frame has a plate including at least one protrusion. Further, the second arm is integral with the first arm. Additionally, the tab is formed from a distal end of the first arm so as to present a shoulder of the first arm. The shoulder is configured for receiving the fork bolt in the latched position so that the fork bolt is disposed adjacent to and in contact with the shoulder in the latched position, thereby optimizing alignment between the fork bolt and the detent lever in the latched position.

A detent lever configured for retaining a fork bolt of a latch assembly of a vehicle includes a first arm configured for retaining the fork bolt in a latched position and presenting a first surface extending along a plane, wherein a proximal end of the first arm defines a circular bore therethrough. The detent lever also includes a tab formed from a distal end of the first arm so as to present a shoulder of the first arm that is configured for receiving the fork bolt in the latched position. Further, the detent lever includes a second arm integral with and substantially perpendicular to the first arm, wherein the second arm includes a curvilinear appendage. The fork bolt is disposed adjacent to and in contact with the shoulder in the latched position, so as to optimize alignment between the detent lever and the fork bolt in the latched position.

The latch assembly and detent lever optimize alignment between rotatable components of the latch assembly in the latched position. Further, the latch assembly and detent lever are cost-effective to manufacture as compared to existing latch assemblies and detent levers thereof.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a latch assembly in a latched position including a fork bolt and a detent lever;

FIG. 2 is a schematic plan view of the latch assembly of FIG. 1;

FIG. 3 is a schematic perspective view of the fork bolt of the latch assembly of FIGS. 1 and 2; and

FIG. 4 is a schematic perspective view of the detent lever of the latch assembly of FIGS. 1 and 2.

### DESCRIPTION OF THE PREFERRED EMBODIMENTS

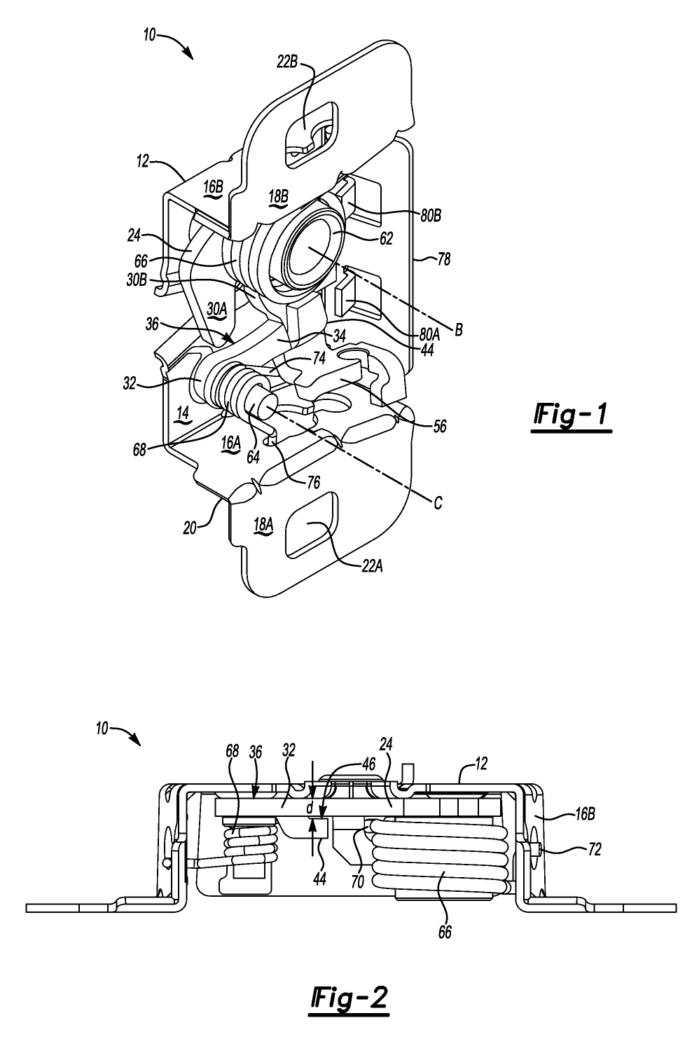

Referring to the drawings, wherein like reference numerals refer to like components, a latch assembly is shown generally at 10 in FIG. 1. The latch assembly 10 may be useful for automotive applications, such as applications relating to a vehicle door or storage compartment. For example, the latch assembly 10 may be configured for attachment to a hood or a body of a vehicle (not shown), i.e., the latch assembly 10 may be a hood latch assembly. However, it is to be appreciated that the latch assembly 10 may also be useful for other non-automotive applications, such as, but not limited to, aviation, rail, and aerospace applications.

Referring to FIG. 1, the latch assembly 10 includes a frame 12 configured for attachment to a vehicle (not shown) and having a base 14. For example, the frame 12 may be generally box-shaped and may include the base 14 with protruding sides 16A, 16B. The frame 12 may also include one or more fastening flanges 18A, 18B that protrude from a distal end 20 of each of the sides 16A, 16B. Further, the fastening flanges 18A, 18B may define one or more holes 22A, 22B for receiving, for example, a bolt or screw. Therefore, the latch assembly 10 may be attached to the vehicle via the fastening flanges 18A, 18B. Alternatively, the latch assembly 10 may be attached to the vehicle via any suitable method known in the art, such as, but not limited to, welding or adhering. The frame 12 may be formed from any material suitable for automotive applications. For example, the frame 12 may be a metal, such as steel or aluminum.

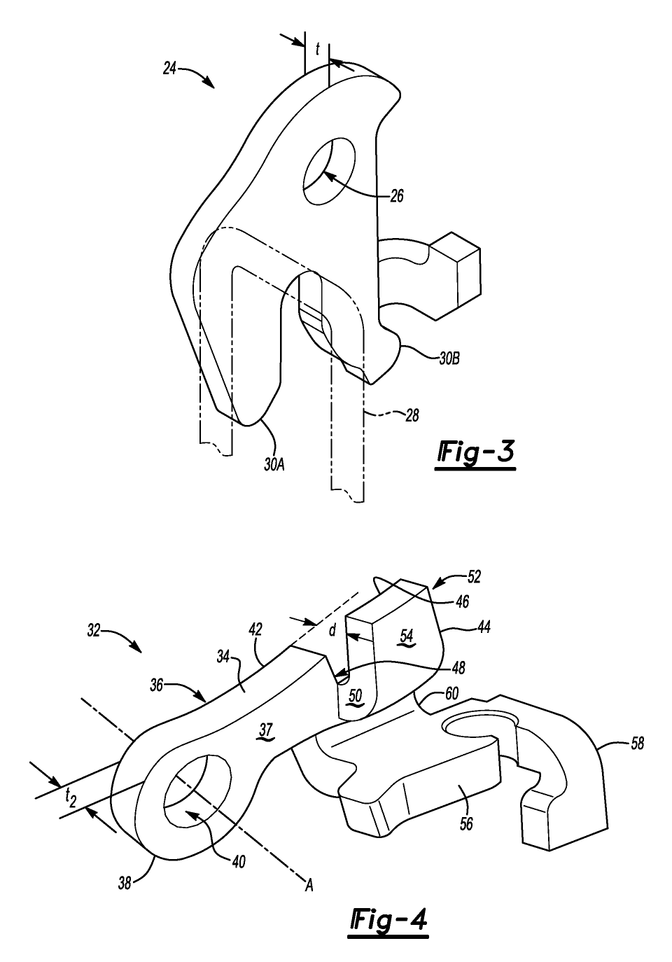

Referring to FIGS. 1 and 3, the latch assembly 10 also includes a fork bolt 24 rotatably attached to the frame 12. That is, the fork bolt 24 is attached to the frame 12 so as to allow rotation of the fork bolt 24 in a plane parallel to the base 14 of the frame 12. To enable such rotation, the fork bolt 24 may define a circular bore 26 (FIG. 3) therethrough. That is, the circular bore 26 may extend entirely through a thickness, t, (FIG. 3) of the fork bolt. As used herein, the terminology “circular” refers to a closed plane curve wherein every point of the curve is equidistant from a fixed point within the curve. Therefore, the circular bore 26 may define a closed circle, as distinguished from a bore connected to a separate channel. The circular bore 26 generally provides a pivot point for rotatable attachment of the fork bolt 24 to the frame 12 of the latch assembly 10.

Referring to FIG. 3, the fork bolt 24 may be configured to engage with a corresponding part on the vehicle, e.g., a striker 28 (shown in phantom in FIG. 3) of a striker assembly (not shown). For example, the fork bolt 24 may include at least two legs 30A, 30B. In a latched position, the striker 28 may be disposed between and in contact with the two legs 30A, 30B so as to latch the latch assembly 10 to the striker 28, as set forth in more detail below. The fork bolt 24 may be formed from any material suitable for automotive applications. For example, the fork bolt 24 may be a metal, such as steel or aluminum.

Referring to FIGS. 1 and 4, the latch assembly 10 also includes a detent lever 32 rotatably attached to the frame 12. The detent lever 32 may retain the fork bolt 24 in the latched position, as set forth in more detail below. That is, referring to FIG. 1, the detent lever 32 is attached to the frame 12 so as to allow rotation of the detent lever 32 in a plane parallel to the base 14 of the frame 12 of the latch assembly 10.

The detent lever 32 includes a first arm, shown generally at 34 in FIGS. 1 and 4. The first arm 34 is configured for retaining the fork bolt 24 in the latched position. That is, the first arm 34 may contact the fork bolt 24 to retain the fork bolt 24 in the latched position, as set forth in more detail below. The first arm 34 has a thickness, t₂, (FIG. 4) that may be less than, substantially equal to, or greater than the thickness, t, (FIG. 3) of the fork bolt 24.

Referring to FIGS. 1 and 4, the first arm 34 presents a first surface 36 extending along a plane substantially parallel to the base 14 (FIG. 1). That is, in operation, the first surface 36 is disposed substantially parallel to the base 14 of the frame 12 of the latch assembly 10. As used herein, the terminology “substantially” is used to represent the inherent degree of uncertainty that may be attributed to any quantitative comparison, value, measurement, or other representation. As such, it refers to an arrangement of elements or features that, while in theory would be expected to exhibit exact correspondence or behavior, may in practice embody something slightly less than exact. The terminology also represents the degree by which a quantitative representation may vary from a stated reference without resulting in a change in the basic function of the subject matter at issue. Further, the first arm presents an opposite surface 37 that is spaced apart from and parallel to the first surface 36.

Referring again to FIG. 4, a proximal end 38 of the first arm 34 may define a circular bore 40 therethrough. That is, the circular bore 40 may extend through the first surface 36 and entirely through the first arm 34 along an axis, A, that is substantially perpendicular to the first surface 36. The circular bore 40 generally provides a pivot point for rotatable attachment of the detent lever 32 to the frame 12 of the latch assembly 10. Although the first arm 34 may have any suitable shape, the first arm 34 is generally shaped so as to extend lengthwise from the circular bore 40 to a distal end 42 of the first arm 34 and thereby present the first surface 36. That is, the first arm 34 may be oblong, as shown in FIG. 4.

Referring to FIG. 4, the first arm 34 has a tab 44. The tab 44 may be configured to retain the fork bolt 24 (FIG. 3) in the latched position, as set forth in more detail below. In particular, referring to FIG. 4, the tab 44 may present a second surface 46 spaced apart from and substantially parallel to the first surface 36 that is configured for optimizing alignment between the fork bolt 24 and the detent lever 32 in the latched position. Stated differently, the second surface 46 and the first surface 36 may be separated by a distance, d, shown in FIGS. 2 and 4. The distance, d, between the first surface 36 and the second surface 46 may be greater than the thickness, t, (FIG. 3) of the fork bolt 24. For example, the distance, d, may be from about 0.25 to about 2, more preferably about 0.5 to about 1 mm greater than the thickness, t, (FIG. 3) of the fork bolt 24. Therefore, in operation, the fork bolt 24 may pivot freely without contacting, e.g., scraping, the second surface 46, as set forth in more detail below.

Referring to FIG. 4, the tab 44 may be formed from the first arm 34 and may be substantially L-shaped. Therefore, the second surface 46 may also be disposed parallel to the base 14 (FIG. 1) of the frame 12. More specifically, referring to FIG. 4, the tab 44 may be formed from the distal end 42 of the first arm 34 so as to present a shoulder 48 of the first arm 34 that is configured for receiving the fork bolt 24 (FIG. 3) in the latched position. That is, referring to FIGS. 1 and 4, the shoulder 48 is configured for receiving the fork bolt 24 in the latched position so that the fork bolt 24 is disposed adjacent to and in contact with the shoulder 48 in the latched position, thereby optimizing alignment between the fork bolt 24 and the detent lever 32 in the latched position, as set forth in more detail below. As shown in FIG. 4, the tab 44 may be a three-dimensional protrusion that includes an upper surface 50, a lower surface 52, and an outer surface 54, in addition to the second surface 46. For example, the tab 44 may be formed by shearing and bending a portion of the distal end 42 of the first arm 34 to form the substantially L-shaped tab 44 and present the resulting shoulder 48.

Referring to FIGS. 1 and 4, the detent lever 32 also includes a second arm 56 substantially perpendicular to the first arm 34. The second arm 56 may be configured for assisting a user when releasing, i.e., unlatching, the fork bolt 24 from the striker 28 (FIG. 3). That is, in one example, the second arm 56 includes a curvilinear appendage 58, as shown in FIG. 4. The curvilinear appendage 58 may be, for example, a finger-hold to assist a user in moving the detent lever 32 to a released position via the second arm 56. The curvilinear appendage 58 may thus be curvilinear in shape so as to provide a comfortable and easily-detectable grasping point for the user, while also providing sufficient leverage to move the detent lever 32 to the released position. Referring to FIG. 4, the curvilinear appendage 58 may extend from a distal end 60 of the second arm 56.

The second arm 56 may be integral with the first arm 34. For example, the detent lever 32 may be bent or creased at an approximate 90 degree angle to define the first arm 34 and the second arm 56. Further, the second arm 56 may extend lengthwise from the distal end 42 of the first arm 34 in a direction substantially perpendicular to the base 14 (FIG. 1) of the frame 12. The detent lever 32 may also be formed from any material suitable for automotive applications. For example, the detent lever 32 may be a metal, such as steel or aluminum.

Referring now to FIG. 1, the latch assembly 10 may further include a first pin 62 configured for receiving the fork bolt 24 and a second pin 64 configured for receiving the detent lever 32. The first pin 62 and the second pin 64 may be configured for supporting the fork bolt 24 and the detent lever 32, respectively. More specifically, as shown in FIG. 1, the first pin 62 and the second pin 64 may extend through the base 14 of the frame 12 so as to be disposed substantially perpendicular to the base 14 and the first surface 36 of the first arm 34. The first pin 62 and the second pin 64 may be formed from any material suitable for automotive applications and may have any suitable shape for supporting the fork bolt 24 and the detent lever 32, respectively. For example, the first pin 62 and/or the second pin 64 may be a rivet. Further, the first pin 62 and/or the second pin 64 may be solid or hollow, and the first pin 62 may be the same or different than the second pin 64.

Referring to FIG. 1, the latch assembly 10 may also include a first resilient member 66 and a second resilient member 68, each configured for assisting rotation of the fork bolt 24 and the detent lever 32, respectively. That is, the first resilient member 66 and the second resilient member 68 may be pre-stressed to hold the fork bolt 24 and the detent lever 32 in a released position, i.e., a position wherein the fork bolt 24 is not engaged with the striker 28 of FIG. 3. The first resilient member 66 and/or the second resilient member 68 may each be a torsion spring, e.g. a coil spring. The first resilient member 66 and the second resilient member 68 may be similarly or differently sized. That is, the first resilient member 66 may assist rotation of the fork bolt 24 to a lesser, equal, or greater degree as compared to the degree with which the second resilient member 68 assists rotation of the detent lever 32. For example, the first resilient member 66 may be a comparatively larger coil spring than the second resilient member 68 depending upon a relative mass of each of the fork bolt 24 and the detent lever 32.

Referring to FIGS. 1 and 2, the first resilient member 66 may be disposed adjacent to and in contact with the fork bolt 24 to assist rotation of the fork bolt 24. More specifically, referring to FIG. 2, one end 70 of the first resilient member 66 may abut, e.g., rest against, the fork bolt 24, whereas another end 72 of the first resilient member 66 may contact, e.g. protrude through, the side 16B of the frame 12 of the latch assembly 10.

Referring to FIG. 1, the second resilient member 68 may contact the second arm 56 of the detent lever 32. Further, the second resilient member 68 may not contact the tab 44 of the detent lever 32. That is, as shown in FIG. 1, a first end 74 of the second resilient member 68 may abut, e.g. rest against, the second arm 56 of the detent lever 32 to assist rotation of the detent lever 32, whereas a second end 76 of the second resilient member 68 may contact, e.g. protrude through, the side 16A of the frame 12 of the latch assembly 10.

Referring to FIG. 1, in one example, the frame 12 of the latch assembly 10 also has a plate 78. The plate 78 may be configured to provide structural support, e.g. rigidity, to the frame 12. As such, the plate 78 may abut one or more of the base 14, sides 16A, 16B, and/or fastening flanges 18A, 18B of the frame 12. For example, the plate 78 may be disposed between the protruding sides 16A, 16B and perpendicular to the base 14 of the frame 12.

Referring again to FIG. 1, the plate 78 of the latch assembly 10 includes at least one protrusion 80A. The at least one protrusion 80A may be configured to stop rotation of at least one of the fork bolt 24 and the detent lever 32. That is, the at least one protrusion 80A of the plate 78 may act as a barrier to over-rotation of the fork bolt 24 and/or the detent lever 32 of the latch assembly 10. The protrusion 80A may be integral with the plate 78, i.e., formed from the plate 78, or may be, for example, welded, adhered, or otherwise attached to the plate 78. Further, the at least one protrusion 80A may protrude toward at least one of the fork bolt 24 or the detent lever 32. That is, the protrusion 80A may protrude into the latch assembly 10, i.e., in a direction toward the fork bolt 24 or the detent lever 32. In one example, the plate 78 may include two protrusions 80A, 80B wherein one protrusion 80A provides a stop for the fork bolt 24 and the other protrusion 80B provides a stop for the detent lever 32.

In operation, and described with reference to FIG. 1, the first pin 62 may support the fork bolt 24 and the first resilient member 66. That is, the first pin 62 may be inserted through the circular bore 26 (FIG. 3) of the fork bolt 24 and through the first resilient member 66 to rotatably attach the fork bolt 24 to the frame 12. In such a configuration, the first resilient member 66 may retain the fork bolt 24 against the base 14 of the frame 12 of the latch assembly 10. That is, the fork bolt 24 may not translate laterally along a longitudinal axis, B (FIG. 1), of the first pin 62.

Likewise, referring to FIG. 1, the second pin 64 may support the detent lever 32 and the second resilient member 68. That is, the second pin 64 may be inserted through the circular bore 40 (FIG. 4) of the detent lever 32 and through the second resilient member 68 to rotatably attach the detent lever 32 to the frame 12. In such a configuration, the second resilient member 68 may retain the detent lever 32 against the base 14 of the frame 12 of the latch assembly 10. That is, the detent lever 32 may not translate laterally along a longitudinal axis, C (FIG. 1), of the second pin 64.

Referring again to FIGS. 1, 3, and 4, in the latched position, the fork bolt 24 (FIG. 3) abuts the shoulder 48 (FIG. 4) of the first arm 34. However, it is to be appreciated that, due to the shape and configuration of the tab 44, the fork bolt 24 does not contact the opposite surface 37 (FIG. 4) of the first arm 34 in the latched position. That is, with reference to FIG. 4, in the latched position, the fork bolt 24 nestles into a pocket defined by the tab 44 and the shoulder 48 of the first arm 34. Since the distance, d, between the second surface 46 of the tab 44 and the first surface 36 of the first arm 34 may be greater than the thickness, t, (FIG. 3) of the fork bolt 24, the fork bolt 24 fits within the pocket, but is restrained from translating perpendicularly to the base 14 by the second surface 46 of the tab 44. That is, the shoulder 48 is configured for receiving the fork bolt 24 in the latched position so that the fork bolt 24 is disposed adjacent to and in contact with the shoulder 48 in the latched position. Therefore, in operation, the fork bolt 24 rests against the shoulder 48 so that alignment of the fork bolt 24 and the detent lever 32 is optimized by the shoulder 48 and the second surface 46 of the tab 44. Thus, the fork bolt 24 is optimally aligned with the detent lever 32 of the latch assembly 10 in the latched position.

Further, with reference to FIG. 2, the tab 44 is also disposed adjacent to the fork bolt 24 in the latched position, thereby optimizing alignment between the fork bolt 24 and the tab 44 so as to optimize alignment between the fork bolt 24 and the detent lever 32 in the latched position. In particular, the tab 44, more specifically the second surface 46 of the tab 44, is configured to optimize and maintain alignment between the fork bolt 24 and the detent lever 32 in the latched position. That is, the tab 44 minimizes misalignment of the fork bolt 24 and the detent lever 32 during operation by maintaining the fork bolt 24 and the detent lever 32 in substantially the same plane, i.e., in alignment. Stated differently, the second surface 46 of the tab 44 minimizes movement of the fork bolt 24 in a direction perpendicular to the base 14 of the frame 12. Further, the distance, d, (FIG. 4) allows for examples where the thickness, t, (FIG. 3) of the fork bolt 24 is greater than the thickness, t₂, (FIG. 4) of the detent lever 32, while still allowing for optimized alignment between the fork bolt 24 and the detent lever 32 in the latched position.

Referring again to FIG. 1, in operation, to release the fork bolt 24 from the latched position (the position in which the fork bolt 24 is latched to the striker 28 of FIG. 3), the detent lever 32 may rotate away from the fork bolt 24 in a clockwise direction to release the fork bolt 24 from the striker 28 (FIG. 3), i.e., to situate the legs 30A, 30B of the fork bolt 24 so that the striker 28 (FIG. 3) is releasable from the fork bolt 24. Stated differently, when the detent lever 32 rotates in a clockwise direction away from the fork bolt 24, the fork bolt 24 rotates by the force of the first resilient member 66 to release the striker 28. The striker 28 (FIG. 3) can then be moved out of the latch assembly 10 to release, for example, the vehicle hood (not shown) from the vehicle body (not shown).

Therefore, the latch assembly 10 optimizes alignment between rotatable components, e.g., the fork bolt 24 and the detent lever 32, of the latch assembly 10 in the latched position. That is, referring to FIG. 2, any gap between the tab 44 and the fork bolt 24 may be substantially minimized in the latched position. Stated differently, the tab 44 may be adjacent to the fork bolt 24 so as to align the fork bolt 24 and the tab 44 to minimize separation between the fork bolt 24 and the detent lever 32 in the latched position. Therefore, the latch assembly 10 minimizes misalignment of the fork bolt 24 and the detent lever 32 to enable efficient operation of the latch assembly 10.

Further, the latch assembly 10 is cost-effective to manufacture as compared to existing latch assemblies since the tab 44 may be formed by shearing and bending a portion of the distal end 42 of the first arm 34. That is, complex forming steps may be minimized since the tab 44 may be formed by bending and shearing the first arm 34 to form the substantially L-shaped tab 44 and present the resulting shoulder 48. Since the tab 44 may be bent and sheared from a portion of the distal end 42 of the first arm 34, excellent tolerance, i.e., minimal distance, between the upper surface 50 (FIG. 4) of the tab 44 and the shoulder 48 may be obtained. Such excellent tolerance therefore minimizes additional manufacturing processes necessary to improve tolerances between surfaces, such as are often required for existing latch assemblies.

Secondly, referring to FIG. 4, forming the tab 44 from the first arm 34 rather than from the second arm 56 allows for optimization of the distance, d, between the first surface 36 of the first arm 34 and the second surface 46 of the tab 44. Such optimization allows for tighter tolerances, and therefore optimal alignment, between the fork bolt 24 and the detent lever 32 in the latched position as compared to existing latch assemblies. Finally, the shape of the tab 44 formed via bending and shearing of the first arm 34 allows for optimal alignment of the fork bolt 24 and the detent lever 32. As compared to existing latch assemblies, the second surface 46 of the tab 44 provides a larger surface area for guiding and/or minimizing misalignment of the fork bolt 24 with respect to the detent lever 32 in the latched position. That is, the second surface 46 of the tab 44 has a greater surface area than, for example, the upper surface 50 of the tab, and therefore provides an excellent guide surface as compared to existing latch assemblies.

While the best modes for carrying out the invention have been described in detail, those familiar with the art to which this invention relates will recognize various alternative designs and embodiments for practicing the invention within the scope of the appended claims.

1. A latch assembly comprising:
a frame configured for attachment to a vehicle and having a base;
a fork bolt rotatably attached to said frame; and
a detent lever rotatably attached to said frame and including;
a first arm configured for retaining said fork bolt in a latched position and having a tab;
wherein said first arm presents a first surface extending along a plane substantially parallel to said base;
wherein said tab presents a second surface spaced apart from and substantially parallel to said first surface that is configured for optimizing alignment between said fork bolt and said detent lever in said latched position; and
a second arm substantially perpendicular to said first arm.

2. The latch assembly of claim 1, wherein a distance between said first surface and said second surface is greater than a thickness of said fork bolt.

3. The latch assembly of claim 1, wherein said tab is formed from said first arm.

4. The latch assembly of claim 3, wherein said tab is substantially L-shaped.

5. The latch assembly of claim 3, wherein said tab is formed from a distal end of said first arm so as to present a shoulder of said first arm that is configured for receiving said fork bolt in said latched position.

6. The latch assembly of claim 5, wherein said fork bolt is disposed adjacent to and in contact with said shoulder in said latched position.

7. The latch assembly of claim 6, wherein said first arm further presents an opposite surface that is spaced apart from and parallel to said first surface.

8. The latch assembly of claim 7, wherein said fork bolt does not contact said opposite surface of said first arm in said latched position.

9. The latch assembly of claim 3, wherein a proximal end of said first arm defines a circular bore therethrough.

10. The latch assembly of claim 1, further including a first resilient member and a second resilient member each configured for assisting rotation of said fork bolt and said detent lever, respectively.

11. The latch assembly of claim 10, wherein said second resilient member contacts said second arm.

12. The latch assembly of claim 11, wherein said second resilient member does not contact said tab.

13. The latch assembly of claim 1, wherein said second arm is integral with said first arm.

14. The latch assembly of claim 1, wherein said latch assembly is configured for attachment to a body of the vehicle.

15. A latch assembly comprising:
a frame configured for attachment to a vehicle and having a plate including at least one protrusion;
a fork bolt rotatably attached to said frame; and
a detent lever rotatably attached to said frame and including;
a first arm configured for retaining said fork bolt in a latched position and having a tab formed from a distal end of said first arm so as to present a shoulder of said first arm; and
a second arm integral with and substantially perpendicular to said first arm;
wherein said shoulder is configured for receiving said fork bolt in said latched position so that said fork bolt is disposed adjacent to and in contact with said shoulder in said latched position, thereby optimizing alignment between said fork bolt and said detent lever in said latched position.

16. The latch assembly of claim 15, wherein said at least one protrusion is configured to stop rotation of at least one of said fork bolt and said detent lever.

17. The latch assembly of claim 15, wherein said at least one protrusion protrudes toward at least one of said fork bolt or said detent lever.

18. A detent lever configured for retaining a fork bolt of a latch assembly of a vehicle, the detent lever comprising:
a first arm configured for retaining the fork bolt in a latched position and presenting a first surface extending along a plane;
wherein a proximal end of said first arm defines a circular bore therethrough;
a tab formed from a distal end of said first arm so as to present a shoulder of said first arm that is configured for receiving the fork bolt in said latched position; and
a second arm integral with and substantially perpendicular to said first arm;
wherein said second arm includes a curvilinear appendage;
wherein the fork bolt is disposed adjacent to and in contact with said shoulder in said latched position, so as to optimize alignment between said detent lever and the fork bolt in said latched position.

19. The detent lever of claim 18, wherein said tab presents a second surface spaced apart from and substantially parallel to said first surface that is configured for optimizing alignment between said detent lever and the fork bolt in said latched position.

20. The detent lever of claim 19, wherein a distance between said first surface and said second surface is greater than a thickness of the fork bolt.
